(19) United States
(12) Patent Application Publication
(10) Pub. No.: US 2026/0246179 A1
(43) Pub. Date: Aug. 20, 2026

(54) COAXIAL-CONNECTOR CONNECTION STRUCTURE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Yutaka KOBAYASHI, Mie (JP); Hiroyuki ISHIGURE, Mie (JP)

(21) Appl. No.: 19/489,587

(22) PCT Filed: May 28, 2024
(86) PCT No.: PCT/JP2024/019486

§ 371 Date: Dec. 3, 2025

(30) Foreign Application Priority Data
Jun. 7, 2023 (JP) 2023-093723

(51) Int. Cl. H01R 13/187; H01R 13/426; H01R 24/40

(52) U.S. Cl. CPC H01R 13/187; H01R 13/426; H01R 24/40

(57) ABSTRACT

In a coaxial connector connection structure for connecting a first coaxial connector and a second coaxial connector, the first coaxial connector includes a first inner conductor and a first outer conductor surrounding an outer peripheral side of the first inner conductor, and the second coaxial connector includes a second inner conductor and a second outer conductor surrounding an outer peripheral side of the second inner conductor. The first inner conductor includes an inner resilient piece resiliently deformable in an in-out direction. The second inner conductor includes an inner connecting tube portion. The first inner conductor is inserted and connected to the second inner conductor with the inner resilient piece resiliently held in contact with an inner peripheral surface of the inner connecting tube portion.

### TECHNICAL FIELD

The present disclosure relates to a coaxial connector connection structure.

### BACKGROUND

Patent Document 1 discloses a coaxial connector connection structure of a coaxial connector and a mating coaxial connector. The coaxial connector is provided with a center contact including a connecting portion. The connecting portion includes a pair of resilient sandwiching pieces facing each other. By sandwiching a pin-like mating center contact by the both resilient sandwiching pieces, the connecting portion and the mating center contact are connected. Each resilient sandwiching piece is formed into a vertically long strip plate shape and formed with a contact point curved inward on an upper end.

### PRIOR ART DOCUMENT

### Patent Document

Patent Document 1: JP 2016-062661 A

### SUMMARY OF THE INVENTION

### Problems to be Solved

However, according to a technique disclosed in Patent Document 1, the resilient sandwiching pieces are located outside the mating center contact. Thus, the outer shape of a connected body of the center contact and the mating center contact depends on the shape of the resilient sandwiching pieces and this outer shape easily changes in a connection direction. Then, in the coaxial connector connection structure, a distance between an inner conductor and an outer conductor varies in a complicated manner and a design for obtaining desired communication performance possibly becomes difficult.

Accordingly, the present disclosure aims to provide a coaxial connector connection structure easily improving communication performance.

### Means to Solve the Problem

The present disclosure is directed to a coaxial connector connection structure for connecting a first coaxial connector and a second coaxial connector, the first coaxial connector including a first inner conductor and a first outer conductor surrounding an outer peripheral side of the first inner conductor, the second coaxial connector including a second inner conductor and a second outer conductor surrounding an outer peripheral side of the second inner conductor, the first inner conductor including an inner resilient piece resiliently deformable in an in-out direction, the second inner conductor including an inner connecting tube portion, and the first inner conductor being inserted and connected to the second inner conductor with the inner resilient piece resiliently held in contact with an inner peripheral surface of the inner connecting tube portion.

### EFFECT OF THE INVENTION

According to the present disclosure, it is possible to provide a coaxial connector connection structure easily improving communication performance.

### BRIEF DESCRIPTION OF THE DRAWINGS

FIG. 1 is a perspective view showing a device provided with a coaxial connector connection structure according to an embodiment.

FIG. 2 is a section along II-II of FIG. 1.

FIG. 3 is a perspective view showing the coaxial connector connection structure.

FIG. 4 is an exploded perspective view showing the connection structure.

FIG. 5 is an enlarged section of FIG. 3.

FIG. 6 is a perspective view showing the tip of a second coaxial connector.

FIG. 7 is a partial section showing a coaxial connector connection structure according to a modification.

FIG. 8 is a partial section showing a coaxial connector connection structure according to another modification.

### DETAILED DESCRIPTION TO EXECUTE THE INVENTION

### Description of Embodiments of Present Disclosure

First, embodiments of the present disclosure are listed and described.

The coaxial connector connection structure of the present disclosure is as follows.

(1) The coaxial connector connection structure of the present disclosure is for connecting a first coaxial connector and a second coaxial connector, the first coaxial connector including a first inner conductor and a first outer conductor surrounding an outer peripheral side of the first inner conductor, the second coaxial connector including a second inner conductor and a second outer conductor surrounding an outer peripheral side of the second inner conductor, the first inner conductor including an inner resilient piece resiliently deformable in an in-out direction, the second inner conductor including an inner connecting tube portion, and the first inner conductor being inserted and connected to the second inner conductor with the inner resilient piece resiliently held in contact with an inner peripheral surface of the inner connecting tube portion.

Since the first inner conductor is inserted and connected to the second inner conductor with the inner resilient piece resiliently held in contact with the inner peripheral surface of the inner connecting tube portion, the outer shape of a connected body of the first and second inner conductors hardly changes in a connection direction of the first and second coaxial connectors. In this way, a shape for obtaining desired communication performance is easily designed and the coaxial connector connection structure easily improving communication performance can be provided.

(2) In the coaxial connector connection structure of (1), the first inner conductor may include a plurality of the inner resilient pieces, the plurality of inner resilient pieces may be arranged at intervals along a circumferential direction of the inner connecting tube portion, and a gap for avoiding mutual contact of adjacent ones of the inner resilient pieces may be formed between the adjacent inner resilient pieces, out of the plurality of inner resilient pieces, with the plurality of inner resilient pieces resiliently held in contact with the inner peripheral surface of the inner connecting tube portion.

In this case, even if the plurality of resilient pieces are resiliently deformed inward when the first inner conductor is inserted into the second inner conductor, the plurality of resilient pieces hardly contact each other. Thus, the first inner conductor is smoothly inserted and connected to the second inner conductor.

(3) In the coaxial connector connection structure of (1) or (2), the inner connecting tube portion may include a recess recessed from a tip side toward a base end side of the inner resilient piece, and a width of the recess in a circumferential direction may be smaller than that of the inner resilient piece in the circumferential direction.

In this way, the inner resilient piece is smoothly inserted into the inner connecting tube portion without being fit into the recess.

(4) In the coaxial connector connection structure of any one of (1) to (3), a contact pressure of the inner resilient piece with the inner connecting tube portion may be set to keep an initial shape of the inner connecting tube portion with the inner resilient piece resiliently held in contact with the inner connecting tube portion.

In this way, the first and second inner conductors can be satisfactorily connected by suppressing the deformation of the inner connecting tube portion.

(5) In the coaxial connector connection structure of any one of (1) to (4), the first inner conductor may be a press-worked product of a metal plate.

It is assumed that the outer shape of the inner resilient piece is easily formed into a concave-convex shape when the first inner conductor is the press-worked product of the metal plate. Also in this case, by arranging the inner connecting tube portion outside the inner resilient piece, the outer shape of the connected body of the first and second inner conductors hardly changes in the connection direction of the first and second coaxial connectors. In this way, even if the first inner conductor is the press-worked product of the metal plate, the shape for obtaining desired communication performance is easily designed and the coaxial connector connection structure easily improving communication performance can be provided.

(6) In the coaxial connector connection structure of (5), the second inner conductor may include an opposite side connecting tube portion, an outer diameter of the opposite side connecting tube portion may be smaller than that of the inner connecting tube portion, a tapered portion having an outer diameter gradually reduced from the inner connecting tube portion toward the opposite side connecting tube portion may be provided between the inner connecting tube portion and the opposite side connecting tube portion, and a slit along the circumferential direction of the inner connecting tube portion may be formed in a boundary between the inner connecting tube portion and the tapered portion.

In this case, since the slit along the circumferential direction of the inner connecting tube portion is formed in the boundary between the inner connecting tube portion and the tapered portion, the gradually narrowed tapered portion can be easily formed with respect to the inner connecting tube portion.

(7) In the coaxial connector connection structure of any one of (1) to (6), the inner resilient piece may include an inner inclined portion inclined outward from a base end toward a tip of the inner resilient piece, and at least a part of the inner inclined portion may be inclined toward a center axis of the inner connecting tube portion with distance from a tip of the inner connecting tube portion outside a tip opening of the inner connecting tube portion in a connection direction of the first coaxial connector and the second coaxial connector.

In this way, it is suppressed that the outer shape of the connected body of the first and second inner conductors suddenly changes outside the tip of the inner connecting tube portion. In this way, the shape for obtaining desired communication performance is easily designed and the coaxial connector connection structure easily improving communication performance can be provided.

(8) In the coaxial connector connection structure of any one of (1) to (7), one of the first outer conductor and the second outer conductor may include an outer resilient piece resiliently deformable in the in-out direction, the other of the first outer conductor and the second outer conductor may include an outer connecting tube portion, and the other of the first outer conductor and the second outer conductor may be inserted and connected to the one of the first outer conductor and the second outer conductor with the outer resilient piece resiliently held in contact with an outer peripheral surface of the outer connecting tube portion.

Since the other including the outer connecting tube portion, out of the first and second outer conductors, is inserted and connected to the one including the outer resilient piece, out of the first and second outer conductors, the outer connecting tube portion is arranged inside. Thus, the inner shape of a connected body of the first and second outer conductors hardly changes in the connection direction of the first and second coaxial connectors. In this way, a distance between the inner and outer conductors hardly changes in the connection direction, and the shape for obtaining desired communication performance is easily designed. Hence, the coaxial connector connection structure easily improving communication performance can be provided.

(9) In the coaxial connector connection structure of (8), the first outer conductor may include the outer resilient piece, the second outer conductor may include the outer connecting tube portion, and the second outer conductor may be inserted and connected to the first outer conductor with the outer resilient piece resiliently held in contact with the outer peripheral surface of the outer connecting tube portion.

Since the first coaxial connector includes both the inner connecting tube portion and the outer connecting tube portion, the inner connecting tube portion and the outer connecting tube portion are easily held on the same axis and good communication performance is easily obtained.

(10) In the coaxial connector connection structure of any one of (1) to (7), the first outer conductor may include an inside contacting outer resilient piece resiliently deformable in the in-out direction, the second outer conductor may include an outer connecting tube portion, the first outer conductor may be inserted and connected to the second outer conductor with the inside contacting outer resilient piece resiliently held in contact with an inner peripheral surface of the outer connecting tube portion, and a contact position of the inside contacting outer resilient piece with the inner peripheral surface of the outer connecting tube portion may be located closer to a tip side of the outer connecting tube portion than a contact position of the inner resilient piece with the inner peripheral surface of the inner connecting tube portion in a connection direction of the first coaxial connector and the second coaxial connector.

In this case, since the first inner conductor is inserted and connected to the second inner conductor, the outer shape of the connected body of the first and second inner conductors is assumed to become thinner on the tip side of the inner connecting tube portion. Accordingly, the first outer conductor is inserted and connected to the second outer conductor with the inside contacting outer resilient piece resiliently held in contact with the inner peripheral surface of the outer connecting tube portion. The inner shape of the connected body of the first and second outer conductors can be thinned according to a shape change of the connected body of the first and second inner conductors. Further, the contact position of the inside contacting outer resilient piece with the inner peripheral surface of the outer connecting tube portion is located closer to the tip side of the outer connecting tube portion than the contact position of the inner resilient piece with the inner peripheral surface of the inner connecting tube portion. In this way, the distance between the inner and outer conductors can be made more difficult to change in the connection direction. In this way, a distance change between the inner and outer conductors is suppressed and the shape for obtaining desired communication performance is easily designed.

(11) In the coaxial connector connection structure of (10), the inner resilient piece may include an inner inclined portion inclined outward from a base end toward a tip of the inner resilient piece, at least a part of the inner inclined portion may be inclined toward a center axis of the inner connecting tube portion with distance from a tip of the inner connecting tube portion outside a tip opening of the inner connecting tube portion in the connection direction, the inside contacting outer resilient piece may include an inside contacting outer inclined portion inclined outward from a base end toward a tip of the inside contacting outer resilient piece, and at least a part of the inside contacting outer inclined portion may be inclined toward a center axis of the outer connecting tube portion with distance from a tip of the outer connecting tube portion outside a tip opening of the outer connecting tube portion.

The inner inclined portion of the inner resilient piece and the inside contacting outer inclined portion of the inside contacting outer resilient piece are inclined toward the center axis in parts coming out from the inner connecting tube portion and the outer connecting tube portion. Thus, a distance between the inner resilient piece and the inside contacting outer resilient piece is easily kept constant and the shape for obtaining desired communication performance is easily designed.

### Details of Embodiment of Present Disclosure

A specific example of a coaxial connector connection structure of the present disclosure are described below with reference to the drawings. Note that the present disclosure is not limited to these illustrations, but is represented by claims and intended to include all changes in the scope of claims and in the meaning and scope of equivalents.

### Embodiment

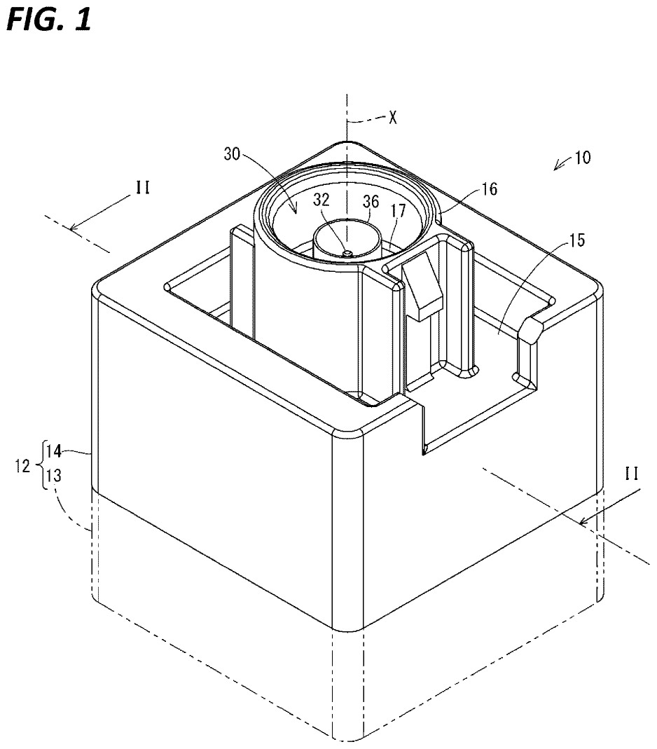

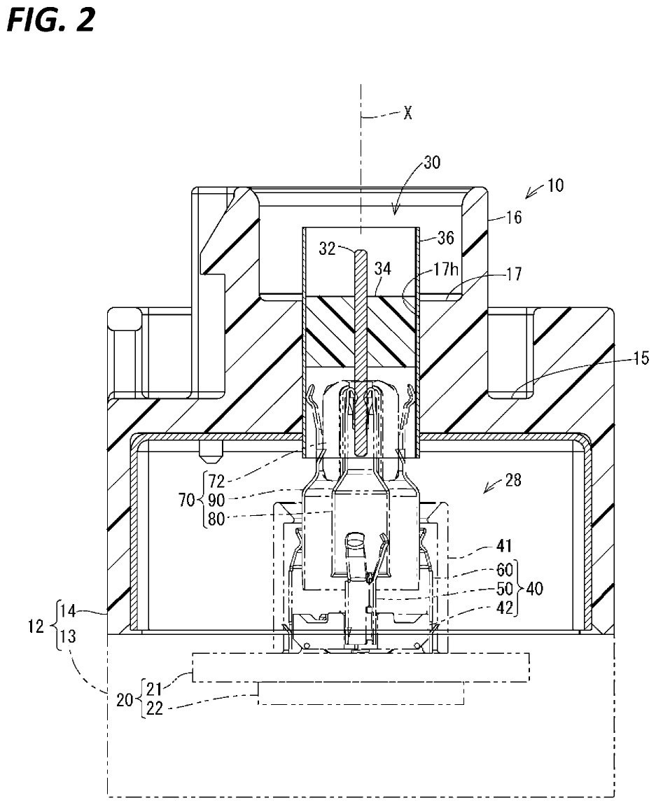

Hereinafter, a coaxial connector connection structure according to an embodiment is described. FIG. 1 is a perspective view showing a device 10 provided with a coaxial connector connection structure 28. FIG. 2 is a section along II-II of FIG. 1.

### Concerning Overall Configuration of Device

The device 10 is, for example, a camera device. The camera device is, for example, an in-vehicle device. The device 10 may not be a camera device.

The device 10 is provided with a case 12, an electrical component 20 and an external connection coaxial connector 30. The electrical component 20 is accommodated in the case 12. The external connection coaxial connector 30 is a connector for connecting the electrical component 20 and an external electrical component. For example, the external connection coaxial connector 30 is a connector, to which a cable connected to the external electrical component is connected.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes the external connection coaxial connector 30.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction along a center axis X of the holding tube portion 16. In this embodiment, the holding/partitioning portion 17 is formed in the intermediate part in the direction along the center axis X of the holding tube portion 16 and at a position near the inner opening. The holding/partitioning portion 17 partitions between a space on the inner opening side and a space on the outer opening side in the holding tube portion 16. The holding/partitioning portion 17 is formed with a holding hole 17h, and the external connection coaxial connector 30 is inserted and held in the holding hole 17h.

The external connection coaxial connector 30 is provided with an external connection inner conductor 32, an external connection dielectric 34 and an external connection outer conductor 36.

The external connection inner conductor 32 is in the form of an elongated bar and made of an electrically conductive material such as metal. The external connection inner conductor 32 is an example of a pin-like opposite mating inner conductor to be inserted and connected to an inner conductor 80 to be described later. The external connection dielectric 34 is formed of an insulator such as resin and surrounds the external connection inner conductor 32. The external connection outer conductor 36 is made of an electrically conductive material such as metal. The external connection outer conductor 36 is formed into a tubular shape surrounding the external connection dielectric 34. The external connection outer conductor 36 is an example of an opposite mating outer conductor to be connected to an outer conductor 90.

The electrical component 20 is, for example, a mounting board having an electronic component mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

The coaxial connector connection structure 28 is incorporated into the device 10. The coaxial connector connection structure 28 is a connection structure of a first coaxial connector 40 and a second coaxial connector 70.

In this embodiment, the first coaxial connector 40 is located on a surface of the circuit board 21 opposite to the imaging element 22. The first coaxial connector 40 is an example of a board side coaxial connector to be fixed to the circuit board 21.

The first coaxial connector 40 is provided with a first inner conductor 50, a first outer conductor 60 surrounding an outer peripheral side of the first inner conductor 50 and a first dielectric 42 located between the first inner conductor 50 and the first outer conductor 60.

The first dielectric 42 surrounds the first inner conductor 50. The first dielectric 42 is formed of an insulator. The first outer conductor 60 surrounds the first dielectric 42. A base end part of the first inner conductor 50 and that of the first outer conductor 60 are fixed to the circuit board 21 by soldering or the like. In this way, the first inner conductor 50 and the first outer conductor 60 are electrically connected to a circuit of the circuit board 21 and fixed in a state projecting from the circuit board 21. The first coaxial connector 40 projects from the circuit board 21 toward the external connection coaxial connector 30. The first dielectric 42 may be omitted.

The second coaxial connector 70 is connected to the first coaxial connector 40. The second coaxial connector 70 includes a second inner conductor 80, a second outer conductor 90 surrounding an outer peripheral side of the second inner conductor 80 and a second dielectric 72 located between the second inner conductor 80 and the second outer conductor 90. The second dielectric 72 surrounds the second inner conductor 80. The second dielectric 72 is formed of an insulator. The second outer conductor 90 surrounds the second dielectric 72.

With the first inner conductor 50 inserted and connected to the second inner conductor 80 and the second outer conductor 90 inserted and connected to the first outer conductor 60, the second coaxial connector 70 is connected to the first coaxial connector 40. The second coaxial connector 70 projects further toward the external connection coaxial connector 30 from the first coaxial connector 40. The second coaxial connector 70 relays and connects the first coaxial connector 40 and the external connection coaxial connector 30. The second coaxial connector 70 is so connected to the first coaxial connector 40 and the external connection coaxial connector 30 as to be capable of changing a posture.

The external connection coaxial connector 30 may be grasped as a third coaxial connector, and the second coaxial connector 70 may be grasped as a relay coaxial connector for relaying and connecting the first coaxial connector 40 and the third coaxial connector.

The external connection coaxial connector 30 is provided on the side of the second case 14, i.e. on a rear side of the case 12. The second coaxial connector 70 is connected to the external connection coaxial connector 30 in the case 12. A cable from outside is connected to the external connection coaxial connector 30, whereby an external electrical component as a connection destination of this cable and the electrical component 20 in the case 12 are electrically connected.

The circuit board 21 is supported at a fixed position in the case 12. In design, the position of the first coaxial connector 40 with respect to the external connection coaxial connector 30 is set to be a fixed position. However, the position of the first coaxial connector 40 with respect to the external connection coaxial connector 30 may possibly deviate from a design position within a tolerance range.

Even if a distance of the external connection 30 from the first coaxial connector 40 varies during an assembly operation or in a completed state of the device 10, this distance change can be absorbed by adjusting an insertion amount of the second coaxial connector 70 into the first coaxial connector 40. Further, even if the external connection coaxial connector 30 deviates from a position facing the first coaxial connector 40 on the same axis, this position deviation is absorbed by the second coaxial connector 70 being inclined with respect to the first coaxial connector 40 and the external connection coaxial connector 30.

### Concerning Coaxial Connector Connection Structure

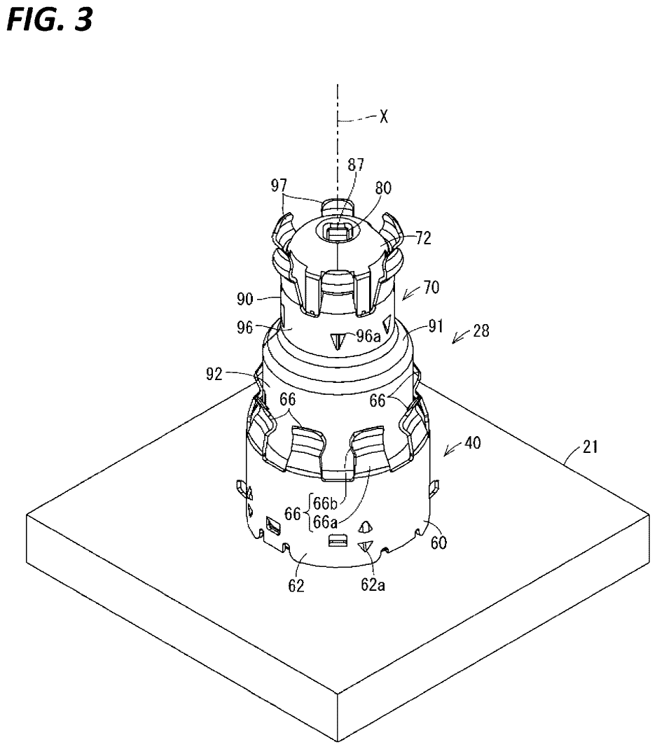

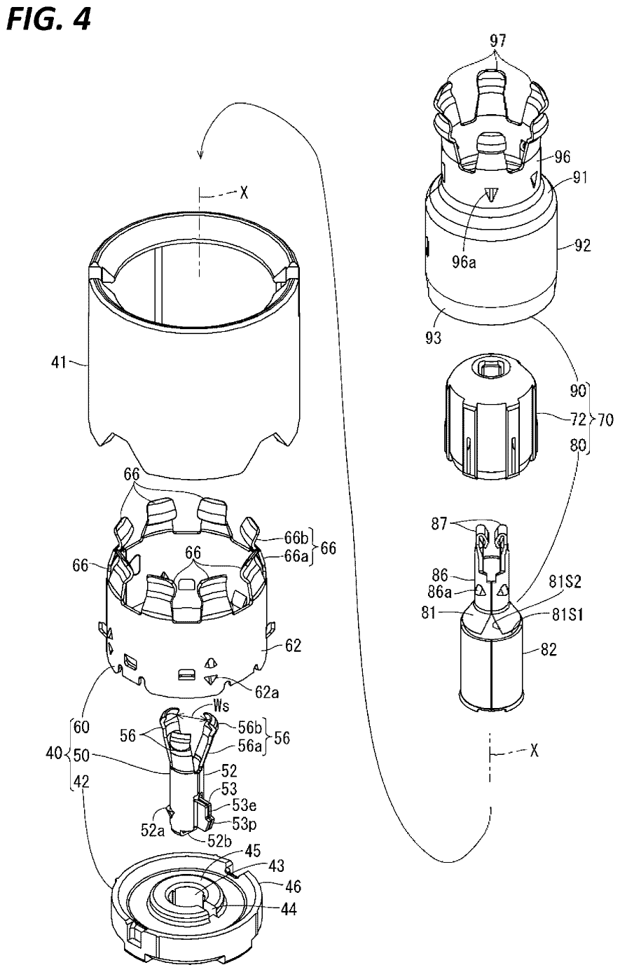

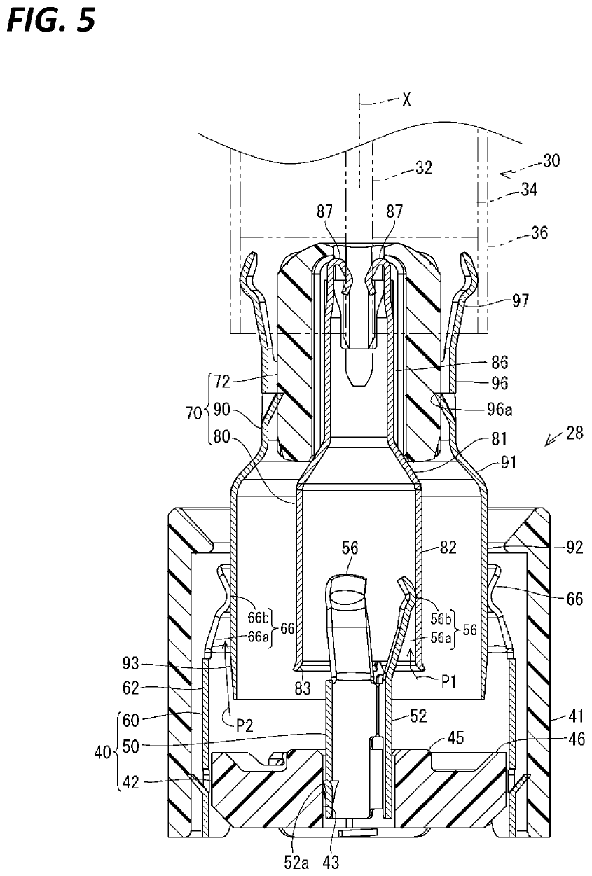

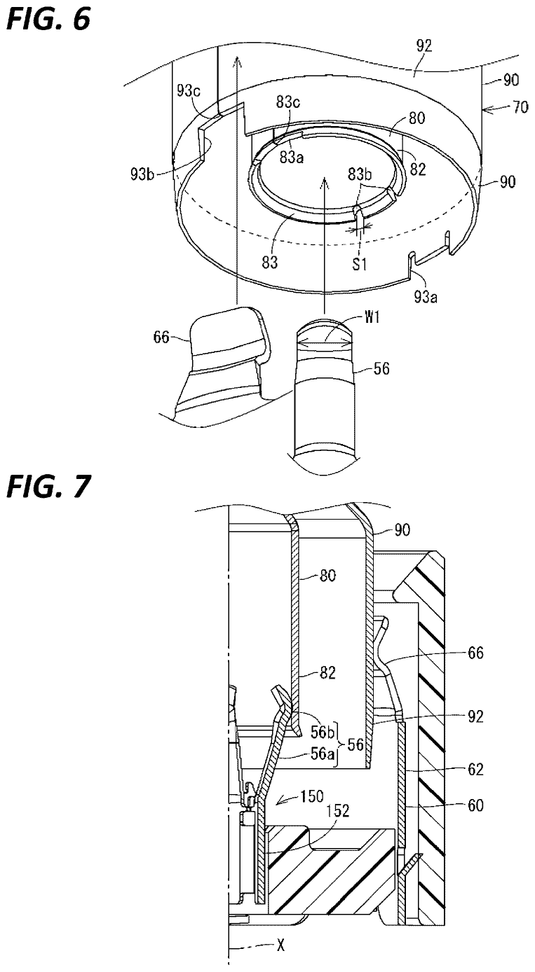

The coaxial connector connection structure 28 is more specifically described. FIG. 3 is a perspective view showing the coaxial connector connection structure 28. FIG. 4 is an exploded perspective view showing the connection structure. FIG. 5 is an enlarged section of FIG. 3. FIG. 6 is a perspective view showing the tip of the second coaxial connector 70. Resilient pieces 56, 66 are partially shown in FIG. 6.

After each of the first coaxial connector 40 and the second coaxial connector 70 is specifically described, the connection structure 28 is more specifically described, focusing on a mutual relationship of the both coaxial connectors 40, 70.

### Concerning First Coaxial Connector

As described above, the first coaxial connector 40 includes the first inner conductor 50, the first outer conductor 60 and the first dielectric 42.

The first inner conductor 50 is an elongated electrically conductive member. In this embodiment, the first inner conductor 50 may be a press-worked product of a metal plate. The press-worked product of the metal plate is a product formed by stamping and bending the metal plate by press working, and shaped by bending the metal plate having a substantially uniform thickness into a predetermined shape. Note that a first inner conductor may be formed by cutting a metal material.

More specifically, the first inner conductor 50 includes a base end side inner tube portion 52 and inner resilient pieces 56.

The base end side inner tube portion 52 is formed into a tubular shape, more specifically a hollow cylindrical shape. A base end part of the first inner conductor 50 is accommodated and held in the first dielectric 42. Note that, in the first coaxial connector 40, a tip is an end on a side where the second coaxial connector 70 is connected, and a base end is an end opposite to the tip, here an end facing the circuit board 21.

A positioning piece 53 is formed to project to an outer peripheral side from a circumferential part in a base end part of the base end side inner tube portion 52. The positioning piece 53 is a plate-like part along a center axis of the base end side inner tube portion 52 and, in this embodiment, a rectangular plate-like part. The positioning piece 53 is configured by overlapping two plate-like parts. In this embodiment, the base end side inner tube portion 52 is formed by press-working a plate-like part into a tube. Plate-like parts project to the outer peripheral side respectively from two edge parts adjacent at a joint of the tube, and the positioning piece 53 is formed by overlapping these two plate-like parts.

A retaining projection 53p to be hooked to the bottom of a positioning groove 44 of the first dielectric 42 is formed on a projecting end part 53e of the positioning piece 53. The retaining projection 53p is formed into a shape to be hooked to the bottom of the positioning groove 44 to make the detachment of the base end side inner tube portion 52 from the first dielectric 42 toward the tip side difficult.

The base end side inner tube portion 52 may be formed with a locking piece 52a to be hooked to the inner peripheral surface of the first dielectric 42 when being press-fit into the first dielectric 42. A projecting piece 52b used for soldering may be provided to extend along a principal surface of the circuit board 21 on the base end of the base end side inner tube portion 52.

The inner resilient pieces 56 project from the tip of the base end side inner tube portion 52. The inner resilient pieces 56 are formed to be resiliently deformable in an in-out direction of the first inner conductor 50.

In this embodiment, a plurality of (here, three) inner resilient pieces 56 extend from the tip of the base end side inner tube portion 52 while being spaced apart in a circumferential direction. Preferably, the plurality of inner resilient pieces 56 are located at equal intervals around the center axis X of the base end side inner tube portion 52.

The inner resilient piece 56 includes an inner inclined portion 56a inclined outward from the tip of the base end side inner tube portion 52 and a curved portion 56b connected to a tip part of the inner inclined portion 56a and having a curved shape convex outward.

If the plurality of inner resilient pieces 56 are inserted into the second inner conductor 80, outward facing top parts of the curved portions 56b are resiliently pressed against the inner peripheral surface of the second inner conductor 80 while the inner inclined portions 56a are resiliently deformed inward. In this way, the first inner conductor 50 is kept in a state electrically connected to the second inner conductor 80.

The outward facing top part of the curved portion 56b contacts the inner peripheral surface of the second inner conductor 80, whereby the inner resilient piece 56 can stably contact the second inner conductor 80 in a limited small area. If the inner resilient piece 56 is formed by press-working a metal plate, a surface of the curved portion 56b opposite to the outward facing top part is a concave surface.

Further, with the plurality of inner resilient pieces 56 inserted in the second inner conductor 80, the plurality of inner resilient pieces 56 are displaced toward a center axis X of the second inner conductor 80. In this way, intervals between the plurality of inner resilient pieces 56 become smaller in the circumferential direction of the base end side inner tube portion 52. A gap Ws for avoiding the mutual contact of adjacent ones of the inner resilient pieces 56 is formed between the inner resilient pieces 56 adjacent in the circumferential direction, out of the plurality of inner resilient pieces 56, with the plurality of inner resilient pieces 56 resiliently held in contact with the inner peripheral surface of an inner connecting tube portion 82 of the second inner conductor 80 (see FIG. 4). The gap Ws is sized to be able to avoid the mutual interference of the inner resilient pieces 56 according to a width and the bent shape of the plurality of inner resilient pieces 56, an inner diameter of the inner connecting tube portion 82 and the like.

Note that a contact pressure of the inner resilient piece 56 with the inner connecting tube portion 82 may be set to keep the initial shape of the inner connecting tube portion 82 with the inner resilient piece 56 resiliently held in contact with the inner connecting tube portion 82. The initial shape of the inner connecting tube portion 82 is a shape before the plurality of inner resilient pieces 56 are inserted into the inner connecting tube portion 82. That is, the above contact pressure of the inner resilient piece 56 may be set to suppress the deformation of the inner connecting tube portion 82. The contact pressure of the inner resilient piece 56 with the inner connecting tube portion 82 is a force of the inner resilient piece 56 for pressing the inner connecting tube portion 82 to an outer peripheral side. That is, since the plurality of inner resilient pieces 56 are resiliently held in contact with the inner peripheral surface of the inner connecting tube portion 82, a force is applied to widen the inner connecting tube portion 82 to the outer peripheral side. The plurality of inner resilient pieces 56 may be resiliently held in contact with the inner peripheral surface of the inner connecting tube portion 82 with such a force as not to widen the inner connecting tube portion 82 to the outer peripheral side. The force of the inner resilient piece 56 for pressing the inner connecting tube portion 82 can be adjusted by changing the width, thickness and material of the inner resilient piece 56 and the thickness and material of a plating layer.

Note that the number of the inner resilient pieces may be two, four or more.

The first dielectric 42 is made of resin or the like into a disk shape. A maximum thickness of the first dielectric 42 is smaller than a length of the base end side inner tube portion 52. The first dielectric 42 is, for example, a molded resin component.

An insertion hole 43, into which the base end part of the first inner conductor 50, more specifically the base end part of the base end side inner tube portion 52, is inserted, is formed in a center of the first dielectric 42. Further, the positioning groove 44 is formed, into which the positioning piece 53 is fit. The positioning groove 44 is in the form of a groove recessed toward an outer peripheral side from a circumferential part of the insertion hole 43 and extending along the center axis X.

By inserting the base end side inner tube portion 52 into the insertion hole 43, the first inner conductor 50 is inserted and held in the first dielectric 42. Preferably, the base end side inner tube portion 52 is press-fit and held in the insertion hole 43.

If a first inner conductor is a cutting component, the first inner conductor is easily firmly held in a first dielectric by the above press-fit structure. If the first inner conductor 50 is a press-worked component of a metal plate, the positioning piece 53 is fit into the positioning groove 44 to enhance holding strength. The inner peripheral surface of the positioning groove 44 clamps the positioning piece 53, whereby it becomes easier to firmly hold the first inner conductor 50 by the first dielectric 42. If the first inner conductor 50 is the press-worked component of the metal plate, the first inner conductor 50 can be manufactured with a low cost.

Further, the retaining projection 53p of the positioning piece 53 is hooked to bite into the bottom of the positioning groove 44, whereby the first inner conductor 50 is less likely to come out from the first dielectric 42 and the first inner conductor 50 is more firmly held.

Further, a holding annular protrusion 45 annularly projecting toward the tip side of the first inner conductor 50 is formed in a part of the first dielectric 42 surrounding the insertion hole 43. The holding annular protrusion 45 holds the base end side inner tube portion 52, whereby the first inner conductor 50 is more firmly held and the first inner conductor 50 is hardly inclined with respect to the first dielectric 42.

The outer peripheral surface of the first dielectric 42 is formed into a short cylindrical surface insertable into an inner peripheral part of the first outer conductor 60. An outer peripheral annular protrusion 46 annularly projecting toward the tip side of the first inner conductor 50 is formed in an outer peripheral part of the first dielectric 42 on the side of the first outer conductor 60. The outer peripheral surface of the first dielectric 42 is formed to be wide in the direction of the center axis X by the outer peripheral annular protrusion 46. Thus, the outer peripheral surface of the first dielectric 42 can face the inner peripheral surface of the first outer conductor 60 in a wide area. In this way, it is easy to firmly hold the first dielectric 42 with respect to the first outer conductor 60 and the first outer conductor 60 is hardly inclined with respect to the first dielectric 42. In this way, a coaxial positional relationship of the first inner conductor 50 and the first outer conductor 60 is easily kept.

The first outer conductor 60 is made of an electrically conductive material such as metal and surrounds the first dielectric 42. Thus, the first dielectric 42 is a tubular member interposed between the first inner conductor 50 and the first outer conductor 60. The first outer conductor 60 is, for example, formed, such as by press-working a metal plate.

In this embodiment, the first outer conductor 60 includes a base end side outer tube portion 62 and outer resilient pieces 66 projecting from the tip of the base end side outer tube portion 62.

The base end side outer tube portion 62 is formed into a tubular shape in which the first dielectric 42 can be arranged, more specifically a hollow cylindrical shape. The first dielectric 42 is accommodated and held in a base end part of the base end side outer tube portion 62.

The base end side outer tube portion 62 may be formed with locking pieces 62a to be hooked to the outer peripheral surface of the first dielectric 42 when the first dielectric 42 is press-fit.

The outer resilient pieces 66 project from the tip of the base end side outer tube portion 62. In this embodiment, a plurality of (here, eight) outer resilient pieces 66 extend from the tip of the base end side outer tube portion 62 while being spaced apart in a circumferential direction. Preferably, the plurality of outer resilient pieces 66 are located at equal intervals around a center axis X of the base end side outer tube portion 62.

The outer resilient piece 66 includes an outer inclined portion 66a inclined inward from the tip of the base end side outer tube portion 62 and a curved portion 66b connected to a tip part of the outer inclined portion 66a and having a curved shape convex inward.

If the plurality of outer resilient pieces 66 are externally fit to the second outer conductor 90, inward facing top parts of the curved portions 66b are resiliently pressed against the outer peripheral surface of the second outer conductor 90 while the outer inclined portions 66a are resiliently deformed outward. In this way, the first outer conductor 60 is kept in a state electrically connected to the second outer conductor 90.

The inward facing top part of the curved portion 66b contacts the outer peripheral surface of the second outer conductor 90, whereby the outer resilient piece 66 can stably contact the second outer conductor 90 in a limited small area. If the outer resilient piece 66 is formed by press-working a metal plate, a surface of the curved portion 66b opposite to the inward facing top part is a concave surface.

Note that the number of the outer resilient pieces may be seven or less or nine or more.

In the direction of the center axis X, a length of the base end side outer tube portion 62 is larger than a thickness of the first dielectric 42. Further, in this embodiment, the length of the base end side outer tube portion 62 is larger than that of the first inner conductor 50. Further, the base end of the outer resilient piece 66 is located more away from the first dielectric 42 than that of the inner resilient piece 56. Furthermore, the tip of the outer resilient piece 66 is located more away from the first dielectric 42 than that of the inner resilient piece 56. However, the curved portions 56b, 66b can contact the second inner conductor 80 or the second outer conductor 90 at the same position in the center axis X.

The first coaxial connector 40 may be surrounded by a tubular connector holder 41. The connector holder 41 is a member made of resin or the like and functions to suppress contact with other members by surrounding the first coaxial connector 40.

### Concerning Second Coaxial Connector

As described above, the second coaxial connector 70 is provided with the second inner conductor 80, the second outer conductor 90 and the second dielectric 72.

The second inner conductor 80 is an elongated electrically conductive member. In this embodiment, the second inner conductor 80 is formed by press-working a metal plate. More specifically, the second inner conductor 80 includes the inner connecting tube portion 82. In this embodiment, the second inner conductor 80 further includes an opposite side connecting tube portion 86. A second inner conductor may be a cutting component.

The inner connecting tube portion 82 is formed into a tubular shape, more specifically a hollow cylindrical shape. An opening end of the inner connecting tube portion 82 is facing toward the first coaxial connector 40. The inner connecting tube portion 82 is a part, to which the plurality of inner resilient pieces 56 of the first inner conductor 50 are inserted and connected.

More specifically, the inner connecting tube portion 82 is a tube elongated along the center axis X. An inner diameter of the inner connecting tube portion 82 is smaller than an outer diameter of a virtual circle connecting the top parts of the plurality of inner resilient pieces 56. The plurality of inner resilient pieces 56 can resiliently contact the inner peripheral surface of the inner connecting tube portion 82 while being resiliently deformed inward.

The opposite side connecting tube portion 86 is located on a side opposite to the first coaxial connector 40 with respect to the inner connecting tube portion 82. In this embodiment, an outer diameter of the opposite side connecting tube portion 86 is smaller than that of the inner connecting tube portion 82.

The opposite side connecting tube portion 86 is connected to the inner connecting tube portion 82 via a tapered portion 81. The tapered portion 81 is a part having a tapered shape having an outer diameter gradually reduced from the inner connecting tube portion 82 toward the opposite side connecting tube portion 86. An opposite side connecting tube portion may be connected to an inner connecting tube portion via a step portion.

A slit 82S1 along a circumferential direction of the inner connecting tube portion 82 is formed in a boundary between the inner connecting tube portion 82 and the tapered portion 81 (see FIG. 4). For example, the slit 81S1 is formed to extend in a region over about ⅓ to ⅔ of the entire circumference of the inner connecting tube portion 82, preferably in a nearly half region. By providing the slit 82S1 in the boundary between the inner connecting tube portion 82 and the tapered portion 81, the tapered portion 81 gradually narrowed in diameter can be easily worked in a state connected to the inner connecting tube portion 82 in the form of a tube having the same diameter.

If the inner connecting tube portion 82 is formed by press working to roll a metal plate, a joint along the center axis X is formed in a circumferential part of the inner connecting tube portion 82. The slit 82S1 may extend on both sides of this joint. In this case, since the metal plate can be easily bent near the joint, the press working of the second inner conductor 80 is facilitated.

A gap 82S2 may be additionally provided in the joint of the tapered portion 81. The gap 82S2 is formed into a triangular gap open from the slit 82S1 toward the tapered portion 81. By this gap 82S2, the tapered portion 81 is easily rolled while interference at the joint is suppressed and the press working of the second inner conductor 80 can be facilitated.

The slit 82S1 and the gap 82S2 may be omitted.

The opposite side connecting tube portion 86 may include resilient pieces 87 projecting toward the tip side. The resilient piece 87 is configured to be resiliently deformable in an in-out direction. The external connection inner conductor 32 is inserted between two resilient pieces 87 from the tip sides of the two resilient pieces 87. The external connection inner conductor 32 is sandwiched by the two resilient pieces 87, whereby the second inner conductor 80 is connected to the external connection inner conductor 32.

The opposite side connecting tube portion 86 may be formed with partial locking pieces 86a lockable to the second dielectric 72.

The second dielectric 72 is made of resin or the like. The second dielectric 72 is, for example, a molded resin component.

The second dielectric 72 is formed into a tubular shape capable of accommodating at least a part of the second inner conductor 80. In this embodiment, the second dielectric 72 is formed into a hollow cylindrical shape. The opposite side connecting tube portion 86 is accommodated into the second dielectric 72. The internal space of the opposite side connecting tube portion 86 is formed in such a size that a base end part of the opposite side connecting tube portion 86 can be press-fit and held therein and the resilient pieces 87 can be allowed to be resiliently deformed in the in-out direction.

One end of the second dielectric 72 contacts the tapered portion 81, whereby the second dielectric 72 can be positioned with respect to the second inner conductor 80. The inner connecting tube portion 82 extends further toward the first coaxial connector 40 than the second dielectric 72.

The second dielectric 72 may surround the inner connecting tube portion 82. A dielectric different from the second dielectric 72 may surround the inner connecting tube portion 82.

The second outer conductor 90 is arranged on an outer peripheral side of the second dielectric 72. The second outer conductor 90 is made of an electrically conductive material such as metal and surrounds the second dielectric 72. The second outer conductor 90 is, for example, formed by press-working a metal plate.

The second outer conductor 90 includes an outer connecting tube portion 92 and an opposite side outer connecting tube portion 96.

The outer connecting tube portion 92 is formed into a tubular shape, more specifically a hollow cylindrical shape. An opening end of the outer connecting tube portion 92 is facing toward the first coaxial connector 40. The outer connecting tube portion 92 is a part to be connected to the first outer conductor 60.

The outer connecting tube portion 92 is located on an outer peripheral side of the inner connecting tube portion 82 while being spaced apart from the inner connecting tube portion 82. An outer diameter of the outer connecting tube portion 92 is larger than an outer diameter of a virtual circle connecting the top parts of the plurality of outer resilient pieces 66. The plurality of outer resilient pieces 66 can resiliently contact the outer peripheral surface of the outer connecting tube portion 92 while being resiliently deformed outward.

The opposite side outer connecting tube portion 96 is located on a side opposite to the first coaxial connector 40 with respect to the outer connecting tube portion 92. In this embodiment, the opposite side outer connecting tube portion 96 is thinner than the outer connecting tube portion 92. The opposite side outer connecting tube portion 96 is connected to the outer connecting tube portion 92 via a tapered portion 91. The tapered portion 91 is a part having a tapered shape gradually thinned from the outer connecting tube portion 92 toward the opposite side outer connecting tube portion 96. An opposite side connecting tube portion may be connected to an outer connecting tube portion via a step portion.

The opposite side outer connecting tube portion 96 may include resilient pieces 97 projecting toward the tip side. The resilient piece 97 is configured to be resiliently deformable in the in-out direction. The external connection outer conductor 36 is externally fit to the outer peripheries of the plurality of resilient pieces 97 from the tip sides of the plurality of resilient pieces 97. The second outer conductor 90 is connected to the external connection outer conductor 36 by resiliently pressing the plurality of resilient pieces 97 against the inner peripheral surface of the external connection outer conductor 36.

The opposite side outer connecting tube portion 96 may be formed with partial locking pieces 96a lockable to the second dielectric 72.

The inner connecting tube portion 82 and the outer connecting tube portion 92 may be formed with recesses 83a, 83b, 83c, 93a, 93b and 93c recessed toward the base end sides thereof when viewed from the tip sides thereof (see FIG. 6).

The recesses 83a, 83b, 83c, 93a, 93b and 93c may be recesses for facilitating working such as carrier cutting during bending or press working. For example, the recess 83b may be a slit-like recess for easily working the tip of the inner connecting tube portion 82 into an outward facing tapered shape. The recesses 83c, 93c may be thin recesses formed by joints of the respective inner connecting tube portion 82 and the outer connecting tube portion 92.

Widths of the recesses 83a, 83b and 83c (e.g. width S1 of the recess 83b) are preferably smaller than a width W1 of the inner resilient pieces 56. In this way, the inner resilient pieces 56 can smoothly move to the inner peripheral side of the inner connecting tube portion 82 without being fit into the recesses 83a, 83b and 83c.

Similarly, widths of the recesses 93a, 93b and 93c are preferably smaller than a width of the outer resilient pieces 66. In this way, the outer resilient pieces 66 can smoothly move to the outer peripheral side of the outer connecting tube portion 92 without being fit into the recesses 93a, 93b and 93c.

### Concerning Connection Structure

A positional relationship of the inner and outer conductors is described on the basis of a state where the first and second coaxial connectors 40, 70 are connected.

With the first and second coaxial connectors 40, 70 connected, the first inner conductor 50 is inserted and connected to the second inner conductor 80 with the plurality of inner resilient pieces 56 resiliently held in contact with the inner peripheral surface of the inner connecting tube portion 82.

Further, the second inner conductor 80 is inserted and connected to the first inner conductor 50 with the plurality of outer resilient pieces 66 resiliently held in contact with the outer peripheral surface of the outer connecting tube portion 92 in the above connected state.

Focusing on a connected body of the first and second inner conductors 50, 80, the first inner conductor 50 including the inner resilient pieces 56 is located in the inner connecting tube portion 82. Thus, the outer shape of the inner connecting tube portion 82, in which a part having the same diameter is continuous, appears on the outer shape of the connected body of the first and second inner conductors 50, 80. That is, the outer shape of the connected body of the first and second inner conductors 50, 80 is a shape, in which the part having the same diameter is continuous, regardless of the bent shape of the inner resilient pieces 56.

Further, focusing on a connected body of the first and second outer conductors 60, 90, the first outer conductor 60 including the outer resilient pieces 66 is located on the outer peripheral side of the outer connecting tube portion 92. Thus, the outer shape of the outer connecting tube portion 92, in which a part having the same diameter is continuous, appears on the inner shape of the connected body of the first and second outer conductors 60, 90. That is, the inner shape of the connected body of the first and second outer conductors 60, 90 is a shape, in which the part having the same diameter is continuous, regardless of the bent shape of the outer resilient pieces 66.

Thus, assuming a coaxial structure including the connected body of the first and second inner conductors 50, 80 as an inner conductor and the connected body of the first and second outer conductors 60, 90 as an outer conductor, a range in which a constant inner diameter and a constant outer diameter are continuous in an axial direction is widely present in this coaxial structure. Thus, an impedance design of the coaxial connector connection structure 28 is facilitated. For example, the connection structure 28 for setting a characteristic impedance to 50Ω is easily designed, assuming a constant distance between the inner and outer conductors.

### Effects, Etc

According to the coaxial connector connection structure 28 configured as described above, the first inner conductor 50 is inserted and connected to the second inner conductor 80 with the inner resilient pieces 56 resiliently held in contact with the inner peripheral surfaces of the inner resilient pieces 56. Thus, the outer shape of the inner conductor, which is the connected body of the first and second inner conductors 50, 80, hardly changes in a connection direction of the coaxial connectors 40, 70. In this way, on the assumption that most part of the inner conductor has a constant outer diameter, the shape for obtaining desired communication performance is easily designed and the coaxial connector connection structure 28 easily improving the communication performance can be provided.

Further, even if a connection amount of the first and second coaxial connectors 40, 70 varies, the constant inter-conductor distance is kept between the inner connecting tube portion 82 and the outer connecting tube portion 92. Thus, communication performance is easily kept constant.

The shapes of the connected body including the first and second inner conductors 50, 80 and the connected body of the first and second outer conductors 60, 90 may be designed on the assumption that air is present therebetween or on the assumption that a dielectric, which is a tangible object such as resin, is present therebetween.

Further, if a gap for avoiding mutual contact is formed between the adjacent inner resilient pieces 56, out of the plurality of inner resilient pieces 56, with the plurality of inner resilient pieces 56 resiliently held in contact with the inner peripheral surface of the inner connecting tube portion 82, the first inner conductor 50 is smoothly inserted and connected to the second inner conductor 80.

Further, if the inner connecting tube portion 82 includes the recesses 83a, 83b and 83c recessed when viewed from the tip side of the inner connecting tube portion 82, the inner resilient pieces 56 are smoothly inserted into the inner connecting tube portion 82 without being fit into the recesses 83a, 83b and 83c if the width (e.g. width S1) of the recesses 83a, 83b and 83c is smaller than the width W1 of the inner resilient pieces 56.

Further, if the contact pressure of the inner resilient piece 56 with the inner connecting tube portion 82 is set to keep the initial shape of the inner connecting tube portion 82, the first and second inner conductors 50, 80 can be satisfactorily connected without causing a contact failure due to the deformation of the inner connecting tube portion 82.

Further, if the first inner conductor 50 is a press-worked product, a concave-convex shape for contact with the inner connecting tube portion 82 is reflected on both surfaces of the inner resilient piece 56. Thus, it is assumed that the outer shape of the inner resilient piece 56 is easily formed into a concave-convex shape. Even in this case, by arranging the inner connecting tube portion 82 outside the inner resilient pieces 56, the outer shape of the connected body of the first and second inner conductors 50, 80 hardly changes in the connection direction. In this way, even if the first inner conductor 50 is a press-worked product, the shape for obtaining desired communication performance is easily designed and the coaxial connector connection structure 28 easily improving communication performance can be provided.

Further, since the slit 81S1 along the circumferential direction of the inner connecting tube portion 82 is formed in the boundary between the inner connecting tube portion 82 and the tapered portion 81, the tapered portion 81 gradually narrowed can be easily formed with respect to the inner connecting tube portion 82.

Further, an impedance is easily adjusted by adjusting the width, the length and the like of the slit 82S1.

The second outer conductor 90 is inserted and connected to the first outer conductor 60 with the outer resilient pieces 66 resiliently held in contact with the outer peripheral surface of the outer connecting tube portion 92. Thus, the inner shape of the connected body of the first and second outer conductors 60, 90 hardly changes in the connection direction. In this way, the distance between the inner and outer conductors is less likely to change in the connection direction, and the shape for obtaining desired communication performance is easily designed. Thus, the coaxial connector connection structure 28 easily improving communication performance can be provided.

Particularly, since the first outer conductor 60 includes the outer resilient pieces 66 and the second outer conductor 90 includes the outer connecting tube portion 92, the second coaxial connector 70 includes the inner connecting tube portion 82 and the outer connecting tube portion 92. Thus, the inner connecting tube portion 82 and the outer connecting tube portion 92 are easily held on the same axis and good communication performance is easily obtained.

### Modifications

At least a part of the inner inclined portion 56a may be inclined toward the center axis X with distance from the tip of the inner connecting tube portion 82 in the connection direction outside the tip opening of the inner connecting tube portion 82.

Also in the above embodiment, at least a part of the inner inclined portion 56a is inclined outside the tip opening of the inner connecting tube portion 82 (see FIG. 5).

To make a step between the inner connecting tube portion 82 and the inner resilient piece 56 as small as possible, a part of the inner inclined portion 56a near the tip is preferably located at the opening of the inner connecting tube portion 82 as in a modification shown in FIG. 7. For example, a region more than half from the base end, out of the inner inclined portion 56a, is preferably located outside the tip opening of the inner connecting tube portion 82. For example, by making a base end side inner tube portion 152 of a first inner conductor 150 corresponding to the first inner conductor 50 shorter, the above configuration can be realized.

In this case, an amount of depression (step) of the inner inclined portion 56a with respect to the opening edge part of the inner connecting tube portion 82 can be reduced in a part coming out from the opening of the inner connecting tube portion 82. The outer shape of a connected body of the first and second inner conductors 150, 80 can be gradually made smaller from the opening edge part of the inner connecting tube portion 82 toward the base end side inner tube portion 52 according to the inclination of the inner inclined portion 56a. In this way, the shape for obtaining desired communication performance is easily designed and the coaxial connector connection structure 28 easily improving communication performance can be provided.

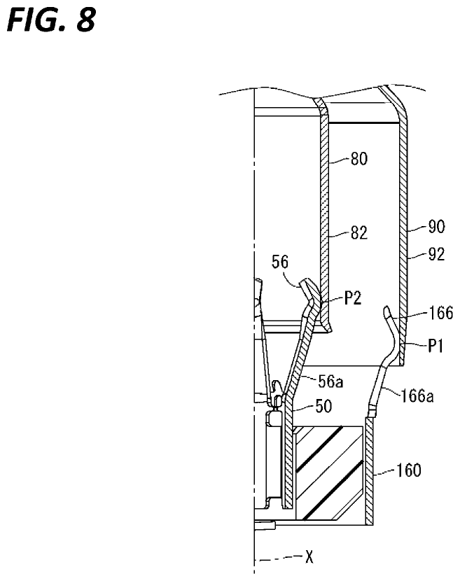

Further, a first outer conductor 160 corresponding to the first outer conductor 60 may include an inside contacting outer resilient piece 166 resiliently deformable in the in-out direction as in a modification shown in FIG. 8. The first outer conductor 160 may be inserted and connected to the second outer conductor 90 with this inside contacting outer resilient piece 166 resiliently held in contact with the inner peripheral surface of the outer connecting tube portion 92.

Further, in the connection direction, a contact position P1 of the inside contacting outer resilient piece 166 with the inner peripheral surface of the outer connecting tube portion 92 may be located closer to the tip of the outer connecting tube portion 92 than a contact position P2 of the inner resilient piece 56 with the inner peripheral surface of the inner connecting tube portion 82. Preferably, the contact position P1 may be located closer to the tip of the outer connecting tube portion 92 than the tip opening of the inner connecting tube portion 82.

In this way, the outer connecting tube portion 92 can be switched to the inside contacting outer resilient piece 166 to make the inner shape thinner in a part where the inner connecting tube portion 82 is switched to the inner resilient piece 56 to make the outer shape thinner in the connection direction. The distance between the inner and outer conductors can be made difficult to change in the connection direction. Further, the outer connecting tube portion 92 surrounds the outer peripheral side of the inner resilient piece 56 at the contact position P2. Thus, even in a region closer to the tip than the inside contacting outer resilient piece 166, a distance change between the inner and outer conductors is suppressed. In this way, the shape for obtaining desired communication performance is easily designed.

In this case, the inside contacting outer resilient piece 166 may include an inside contacting outer inclined portion 166a inclined outward from the base end to the tip of the inside contacting outer resilient piece 166. At least a part of this inside contacting outer inclined portion 166a may be inclined toward the center axis X with distance from the tip of the outer connecting tube portion 92 in the connection direction outside the tip opening of the outer connecting tube portion 92.

In this way, the inner inclined portion 56a of the inner resilient piece 56 and the inside contacting outer inclined portion 166a of the inside contacting outer resilient piece 166 are inclined toward the same side, i.e. toward the center axis X. Thus, a distance between the inner resilient piece 56 and the inside contacting outer resilient piece 166 is more easily kept constant and the shape for obtaining desired communication performance is easily designed.

Note that, in this embodiment, the first coaxial connector 40 is provided with the inner resilient pieces 56 and the outer resilient pieces 66, and the second coaxial connector 70 is provided with the inner connecting tube portion 82 and the outer connecting tube portion 92. However, a first coaxial connector may be provided with inner resilient piece(s) and an outer connecting tube portion, and a second coaxial connector may be provided with an inner connecting tube portion and outer resilient piece(s).

A board side coaxial connector may be provided with an inner connecting tube portion and an outer connecting tube portion, and a relay coaxial connector may be provided with inner resilient piece(s) and outer resilient piece(s).

The configuration according to the above embodiment may be applied to a connection point of a relay coaxial connector and an external connection coaxial connector or may be applied to a connection structure of other coaxial connectors without being limited to the above device.

Note that the respective configurations described in the above embodiment and the respective modifications can be appropriately combined without technically contradicting each other.

### LIST OF REFERENCE NUMERALS

10 device
12 case
13 first case
14 second case
15 bottom portion
16 holding tube portion
17 holding/partitioning portion
17h holding hole
20 electrical component
21 circuit board
22 imaging element
28 connection structure
30 external connection coaxial connector
32 external connection inner conductor
34 external connection dielectric
36 external connection outer conductor
40 first coaxial connector
41 connector holder
42 first dielectric
43 insertion hole
44 positioning groove
45 holding annular protrusion
46 outer peripheral annular protrusion
50 first inner conductor
52 base end side inner tube portion
52a locking piece
52b projecting piece
53 positioning piece
53e projecting end part
53p retaining projection
56 inner resilient piece
56a inner inclined portion
56b curved portion
60 first outer conductor
62 base end side outer tube portion
62a locking piece
66 outer resilient piece
66a outer inclined portion
66b curved portion
70 second coaxial connector
72 second dielectric
80 second inner conductor
81 tapered portion
81S1 slit
81S2 gap
82 inner connecting tube portion
83a, 83b, 83c recess
86 opposite side connecting tube portion
86a locking piece
87 resilient piece
90 second outer conductor
91 tapered portion
92 outer connecting tube portion
93a, 93b, 93c recess
96 opposite side outer connecting tube portion
96a locking piece
97 resilient piece
160 first outer conductor
166 inside contacting outer resilient piece
166a inside contacting outer inclined portion
P1, P2 contact position
Ws gap
X center axis

1. A coaxial connector connection structure for connecting a first coaxial connector and a second coaxial connector,
the first coaxial connector including a first inner conductor and a first outer conductor surrounding an outer peripheral side of the first inner conductor,
the second coaxial connector including a second inner conductor and a second outer conductor surrounding an outer peripheral side of the second inner conductor,
the first inner conductor including an inner resilient piece resiliently deformable in an in-out direction,
the second inner conductor including an inner connecting tube portion, and
the first inner conductor being inserted and connected to the second inner conductor with the inner resilient piece resiliently held in contact with an inner peripheral surface of the inner connecting tube portion.

2. The coaxial connector connection structure of claim 1, wherein:
the first inner conductor includes a plurality of the inner resilient pieces,
the plurality of inner resilient pieces are arranged at intervals along a circumferential direction of the inner connecting tube portion, and
a gap for avoiding mutual contact of adjacent ones of the inner resilient pieces is formed between the adjacent inner resilient pieces, out of the plurality of inner resilient pieces, with the plurality of inner resilient pieces resiliently held in contact with the inner peripheral surface of the inner connecting tube portion.

3. The coaxial connector connection structure of claim 1, wherein:
the inner connecting tube portion includes a recess recessed from a tip side toward a base end side of the inner resilient piece, and
a width of the recess in a circumferential direction is smaller than that of the inner resilient piece in the circumferential direction.

4. The coaxial connector connection structure of claim 1, wherein a contact pressure of the inner resilient piece with the inner connecting tube portion is set to keep an initial shape of the inner connecting tube portion with the inner resilient piece resiliently held in contact with the inner connecting tube portion.

5. The coaxial connector connection structure of claim 1, wherein the first inner conductor is a press-worked product of a metal plate.

6. The coaxial connector connection structure of claim 5, wherein:
the second inner conductor includes an opposite side connecting tube portion,
an outer diameter of the opposite side connecting tube portion is smaller than that of the inner connecting tube portion,
a tapered portion having an outer diameter gradually reduced from the inner connecting tube portion toward the opposite side connecting tube portion is provided between the inner connecting tube portion and the opposite side connecting tube portion, and
a slit along the circumferential direction of the inner connecting tube portion is formed in a boundary between the inner connecting tube portion and the tapered portion.

7. The coaxial connector connection structure of claim 1, wherein:
the inner resilient piece includes an inner inclined portion inclined outward from a base end toward a tip of the inner resilient piece, and
at least a part of the inner inclined portion is inclined toward a center axis of the inner connecting tube portion with distance from a tip of the inner connecting tube portion outside a tip opening of the inner connecting tube portion in a connection direction of the first coaxial connector and the second coaxial connector.

8. The coaxial connector connection structure of claim 1, wherein:
one of the first outer conductor and the second outer conductor includes an outer resilient piece resiliently deformable in the in-out direction,
the other of the first outer conductor and the second outer conductor includes an outer connecting tube portion, and
the other of the first outer conductor and the second outer conductor is inserted and connected to the one of the first outer conductor and the second outer conductor with the outer resilient piece resiliently held in contact with an outer peripheral surface of the outer connecting tube portion.

9. The coaxial connector connection structure of claim 8, wherein:
the first outer conductor includes the outer resilient piece,
the second outer conductor includes the outer connecting tube portion, and
the second outer conductor is inserted and connected to the first outer conductor with the outer resilient piece resiliently held in contact with the outer peripheral surface of the outer connecting tube portion.

10. The coaxial connector connection structure of claim 1, wherein:
the first outer conductor includes an inside contacting outer resilient piece resiliently deformable in the in-out direction,
the second outer conductor includes an outer connecting tube portion,
the first outer conductor is inserted and connected to the second outer conductor with the inside contacting outer resilient piece resiliently held in contact with an inner peripheral surface of the outer connecting tube portion, and
a contact position of the inside contacting outer resilient piece with the inner peripheral surface of the outer connecting tube portion is located closer to a tip side of the outer connecting tube portion than a contact position of the inner resilient piece with the inner peripheral surface of the inner connecting tube portion in a connection direction of the first coaxial connector and the second coaxial connector.

11. The coaxial connector connection structure of claim 10, wherein:
the inner resilient piece includes an inner inclined portion inclined outward from a base end toward a tip of the inner resilient piece,
at least a part of the inner inclined portion is inclined toward a center axis of the inner connecting tube portion with distance from a tip of the inner connecting tube portion outside a tip opening of the inner connecting tube portion in the connection direction,
the inside contacting outer resilient piece includes an inside contacting outer inclined portion inclined outward from a base end toward a tip of the inside contacting outer resilient piece, and
at least a part of the inside contacting outer inclined portion is inclined toward a center axis of the outer connecting tube portion with distance from a tip of the outer connecting tube portion outside a tip opening of the outer connecting tube portion.
